(19) United States
(12) Patent Application Publication
(10) Pub. No.: US 2021/0102321 A1
(43) Pub. Date: Apr. 8, 2021

(54) MELTBLOWN NONWOVEN FABRIC

(71) Applicant: Taiwan Textile Research Institute, New Taipei City (TW)

(72) Inventors: Shang-Chih Chou, New Taipei City (TW); Shao-Yen Chang, New Taipei City (TW); Chun-Hung Lin, New Taipei City (TW); Yuan-Pei Liao, New Taipei City (TW); Yi-Cang Lai, New Taipei City (TW)

(73) Assignee: Taiwan Textile Research Institute, New Taipei City (TW)

(21) Appl. No.: 16/782,082

(22) Filed: Feb. 5, 2020

(30) Foreign Application Priority Data
Oct. 4, 2019 (TW) 108136078

(51) Int. Cl. D04H 1/56; D04H 3/16; D04H 1/4326; D01F 6/66; D01F 6/74

(52) U.S. Cl. CPC D04H 1/565; D04H 3/16; D04H 1/4326; D10B 2401/04; D01F 6/74; D10B 2401/16; D01F 6/66

(57) ABSTRACT

A meltblown nonwoven fabric is provided. The meltblown nonwoven fabric includes a plurality of meltblown fibers adhered to each other. The material of each of the meltblown fibers includes a polyetherimide and a polyimide, or the material of each of the meltblown fibers includes a polyphenylene sulfide and a polyimide, wherein the glass transition temperature of the polyimide is between 128° C. and 169° C., the 10% thermogravimetric loss temperature of the polyimide is between 490° C. and 534° C., and when the polyimide is dissolved in N-methyl-2-pyrrolidone and the solid content of the polyimide is 30 wt %, the viscosity of the polyimide is between 100 cP and 250 cP.

### CROSS-REFERENCE TO RELATED APPLICATION

This application claims the priority benefit of Taiwan application serial no. 108136078, filed on Oct. 4, 2019. The entirety of the above-mentioned patent application is hereby incorporated by reference herein and made a part of this specification.

### BACKGROUND

### Technical Field

The present invention relates to a nonwoven fabric, and in particular to a meltblown nonwoven fabric.

### Description of Related Art

Nonwoven fabric is a product of textiles, which is not made by conventional weaving methods such as weaving or knitting. With the advancement of the textile industry, nonwoven fabrics prepared by meltblowing processes have been developed, which can be applied to diapers, wiping cloths, medical hygiene materials, sportswear and down jackets. At present, the material of the nonwoven fabric prepared by the meltblowing process can be a thermoplastic resin called “engineering plastic” which has excellent heat resistance, chemical resistance, flame retardancy and the like. However, there are still restrictions on the use of engineering plastics. For example, the melt processing temperature of polyetherimide is quite high (between 350° C. and 380° C.), which is not easy to achieve for a general machine. In addition, when poly(vinylidene fluoride) is subjected to high-temperature molding, if the processing temperature is equal to or greater than 320° C., it is easy to produce hydrofluoric acid which has strong corrosivity. Therefore, how to improve the applicability of engineering plastics is still an important topic for active research.

### SUMMARY

The present invention provides a meltblown nonwoven fabric which has good heat resistance, good flame retardancy, good dimensional stability, good dielectric properties, low meltblowing temperature, and no dripping phenomenon after combustion.

The invention further provides a meltblown nonwoven fabric which has good heat resistance, good flame retardancy, good chemical resistance, good thermal shrink resistance, good dielectric properties, low process temperature and no dripping phenomenon after combustion.

The meltblown nonwoven fabric of the present invention includes a plurality of meltblown fibers adhered to each other. The material of each of the plurality of meltblown fibers includes a polyetherimide and a polyimide, wherein the glass transition temperature of the polyimide is between 128° C. and 169° C., the 10% thermogravimetric loss temperature of the polyimide is between 490° C. and 534° C., and when the polyimide is dissolved in N-methyl-2-pyrrolidone (NMP) and the solid content of the polyimide is 30 wt %, the viscosity is between 100 cP and 250 cP.

Another meltblown nonwoven fabric of the present invention includes a plurality of meltblown fibers adhered to each other. The material of each of the plurality of meltblown fibers includes a polyphenylene sulfide and a polyimide, wherein the glass transition temperature of the polyimide is between 128° C. and 169° C., the 10% thermogravimetric loss temperature of the polyimide is between 490° C. and 534° C., and when the polyimide is dissolved in NMP and the solid content of the polyimide is 30 wt %, the viscosity is between 100 cP and 250 cP.

Based on the above, the meltblown nonwoven fabric of the present invention includes the meltblown fibers, the material of each of the meltblown fibers includes the polyetherimide and the polyimide of which the glass transition temperature is between 128° C. and 169° C., the 10% thermogravimetric loss temperature is between 490° C. and 534° C., and when the polyimide is dissolved in NMP and the solid content is 30 wt %, the viscosity is between 100 cP and 250 cP, or the material of each of the meltblown fibers includes the polyphenylene sulfide and the polyimide of which the glass transition temperature is between 128° C. and 169° C., the 10% thermogravimetric loss temperature is between 490° C. and 534° C., and when the polyimide is dissolved in NMP and the solid content is 30 wt %, the viscosity is between 100 cP and 250 cP, so that the meltblown nonwoven fabric has good heat resistance, good flame retardancy, good dielectric properties, low meltblowing temperature and no dripping phenomenon after burning.

In order to make the aforementioned features and advantages of the present invention more comprehensible, embodiments are illustrated in detail hereinafter.

### DESCRIPTION OF THE EMBODIMENTS

Herein, a range represented by being from a value to another value is a schematic representative manner of preventing all values within the range from being listed one by one in the specification. Therefore, a record of a particular value range covers any value within the value range and a smaller value range defined by any value within the value range, like a case in which the any value and the smaller value range are explicitly written in the specification.

Herein, the structure of a polymer or a group is sometimes represented by a skeleton formula. Carbon atoms, hydrogen atoms, and carbon-hydrogen bonds can be omitted in this representation. Certainly, if an atom or an atomic group is definitely drawn in a structural formula, the drawn atom or atomic group prevails.

As used herein, “about”, “approximately”, “essentially” or “substantially” is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, ±20%, ±10%, ±5% of the stated value. Further, as used herein, “about”, “approximately”, “essentially” or “substantially” may depend on measurement properties or other properties to select a more acceptable range of deviations or standard deviations without one standard deviation for all properties.

In order to provide a meltblown nonwoven fabric having good heat resistance, good flame retardancy, good dimensional stability, good dielectric properties, low meltblowing temperature, and no dripping phenomenon after combustion, the present invention provides a meltblown nonwoven fabric, which can achieve the above advantages. Hereinafter, embodiments are listed as examples in which the present invention can be actually implemented accordingly.

An embodiment of the present invention provides a meltblown nonwoven fabric including a plurality of meltblown fibers adhered to each other. In detail, the meltblown fibers are arbitrarily interlaced with each other. In the present embodiment, the basis weight of the meltblown nonwoven fabric is between about 1 g/m² and 100 g/m².

In this embodiment, the material of each of the meltblown fibers includes a polyetherimide and a polyimide. That is, the raw material of the meltblown nonwoven fabric is a masterbatch (i.e., a composition) including a polyetherimide and a polyimide. In detail, in the present embodiment, a method for producing a masterbatch (i.e., a composition) including a polyetherimide and a polyimide comprises performing a melt process on the polyetherimide and the polyimide to mix the polyetherimide and the polyimide. The melt process is a process that melting, mutually bonding and mixing various materials (for example, the polyetherimide and the polyimide) by heating and/or applying pressure. In the present embodiment, the melt process may include, for example, (but is not limited to), a melt compounding process, a thermo-pressing process, a melt blowing process, or melt spinning process. In the present embodiment, the process temperature of the melt process may be between about 300° C. and about 350° C.

In the present embodiment, the meltblown nonwoven fabric may be produced by the steps of melting a composition including a polyetherimide and a polyimide at a high temperature, discharging the molten composition from the spinning nozzle in fibrous form, and then drawing the discharged molten composition in fibrous form by a high-temperature and high-speed gas to obtain a plurality of meltblown fibers on the collecting device. In the present embodiment, a meltblown nonwoven fabric is obtained by directly collecting a plurality of meltblown fibers. However, the present invention is not limited thereto. In other embodiments, the collected meltblown fibers may be subjected to a thermo-pressing process to obtain a meltblown fiber membrane.

In each of the meltblown fibers of the present embodiment, the content of the polyimide may be from about 1 part by weight to about 10 parts by weight based on the content of 100 parts by weight of the polyetherimide. In other words, in the composition including the polyetherimide and the polyimide, the polyimide may be used in an amount of from about 1 part by weight to about 10 parts by weight based on the use amount of 100 parts by weight of the polyetherimide. If the polyimide is used in an amount of less than 1 part by weight, the melt processability of the polyetherimide cannot be remarkably improved to produce the meltblown fibers; and if the polyimide is used in an amount of greater than 10 parts by weight, the continuous processability of the said composition is poor, and it is difficult to manufacture a uniform meltblown fiber nonwoven fabric or a membrane thereof.

The polyetherimide is a thermoplastic non-crystalline polymer with solvent-soluble properties. In the present embodiment, the polyetherimide may include a repeating unit represented by the following formula I:

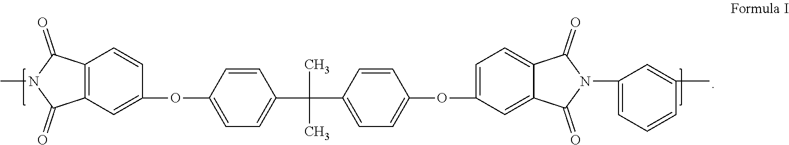

That is, the polyetherimide may be obtained by reacting 4,4′-(4,4′-isopropylidenediphenoxy)bis(phthalic anhydride) (BPADA) with m-phenylenediamine (m-PDA). Further, in the present embodiment, the polyetherimide may be a commercially available product or a recovered powder (i.e., a secondary material), wherein the commercially available product is, for example, spinning-grade ULTEM 9011 PEI and ULTEM 1010 PEI manufactured by Saudi Basic Industries Corporation (Sabic). In this embodiment, the weight average molecular weight of the polyetherimide may be between about 44,000 g/mol and about 50,000 g/mol. In addition, the polyetherimide inherently has good heat resistance, flame retardancy and dyeability, so the meltblown fibers of which the material includes the polyetherimide and the polyimide have good heat resistance, flame retardancy and dyeability.

In the present embodiment, the glass transition temperature of the polyimide is between about 128° C. and about 169° C., the 10% thermogravimetric loss temperature of the polyimide is between about 490° C. and about 534° C., and when the polyimide is dissolved in N-methyl-2-pyrrolidone (NMP) and the solid content of the polyimide is 30 wt %, the viscosity of the polyimide is between about 100 cP and about 250 cP. If the glass transition temperature, the 10% thermogravimetric loss temperature and the viscosity of the polyimide do not fall within the above range, the thermoplastic composition prepared in the subsequent step has poor melt processability and poor thermal stability.

Further, in the present embodiment, the polyimide may include a repeating unit represented by Formula 1:

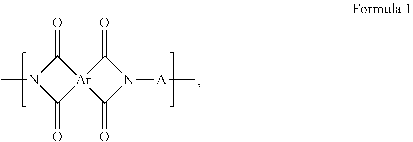

wherein Ar is a tetravalent organic group derived from a tetracarboxylic dianhydride compound containing aromatic group, and A is a divalent organic group derived from a diamine compound containing aromatic group. That is, Ar is a residue in the tetracarboxylic dianhydride compound containing aromatic group other than two carboxylic anhydride groups (—(CO)₂O); and A is a residue in the diamine compound containing aromatic group other than two amino groups (—NH₂). In this embodiment, at least one of the tetravalent organic group and the divalent organic group contains ether group. That is, at least one of the tetracarboxylic dianhydride compound containing aromatic group and the diamine compound containing aromatic group contains ether group. Herein, the tetracarboxylic dianhydride compound containing aromatic group is also referred to as a dianhydride monomer, and the diamine compound containing aromatic group is also referred to as a diamine monomer. In this embodiment, the polyimide is obtained by reacting the dianhydride monomer and the diamine monomer.

In this embodiment, Ar may be

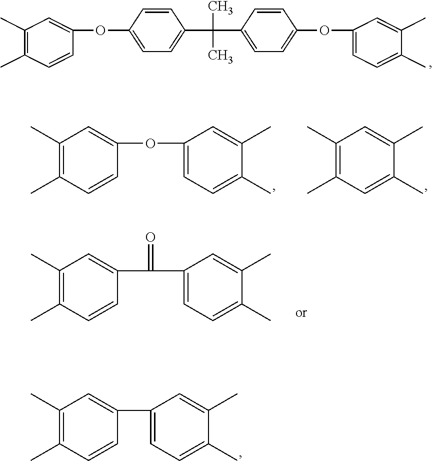

Specifically, the dianhydride monomer used for preparing the polyimide may be 4,4′-(4,4′-isopropylidenediphenoxy)bis(phthalic anhydride (BPADA), oxydiphthalic anhydride (ODPA), pyromellitic dianhydride (PMDA), 3,3′,4,4′-benzophenonetetracarboxylic dianhydride (BTDA), or 3,3′,4,4′-biphenyltetracarboxylic dianhydride (BPDA).

In this embodiment, A may be

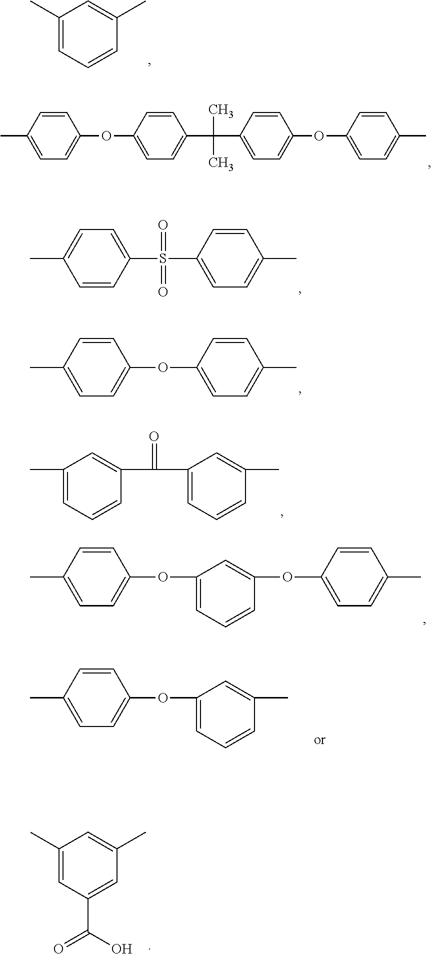

Specifically, the diamine monomer used to prepare the polyimide may be meta-phenylene diamine (m-PDA), 2,2-bis[4-(4-aminophenoxy)phenyl]propane (BAPP), 4,4′-diaminodiphenyl sulfone, 4,4′-oxydianiline (or 4,4′-diaminodiphenyl ether; ODA), 3,3′-diaminobenzophenone, 1,3-bis(4-aminophenoxy)benzene (TPE-R), 3,4′-oxydianiline (or 3,4′-diaminodiphenyl ether) or 3,5-diaminobenzoic acid (DABA).

In detail, in the present embodiment, the polyimide may be prepared, for example, by a polycondensation reaction and a thermal cyclization method, or by a polycondensation reaction and a chemical cyclization method. The polycondensation reaction, the thermal cyclization method, and the chemical cyclization method can each be carried out by any step known to those skilled in the art. In one embodiment, the preparation of the polyimide by a polycondensation reaction and a chemical cyclization method may include the steps of: subjecting a dianhydride monomer and a diamine monomer to a polycondensation reaction in a solvent to form a poly(amic acid) solution, and then adding a dehydrating agent and an imidizing agent to the poly(amic acid) solution to undergo an imidization reaction (i.e., a dehydration-cyclization reaction) to form the polyimide. In another embodiment, the preparation of the polyimide by a polycondensation reaction and a thermal cyclization method may include the steps of: subjecting a dianhydride monomer and a diamine monomer to a polycondensation reaction in a solvent to form a poly(amic acid) solution, and then heating the poly(amic acid) solution to undergo an imidization reaction (i.e., a dehydration-cyclization reaction) to form the polyimide.

The solvent is not particularly limited as long as it can dissolve the dianhydride monomer and the diamine monomer. Specifically, the solvent includes, for example, but is not limited to, an amide-based solvent (such as N,N-dimethylacetamide (DMAc), N,N-dimethylformamide (DMF), N,N′-diethylacetamide, NMP, γ-butyrolactone, or hexamethylphosphoramide); a urea-based solvent (such as tetramethylurea or N,N-dimethylethylurea); an sulfoxide or sulfone-based solvent (such as dimethyl sulfoxide (DMSO), diphenyl sulfone or tetramethyl sulfone); a halogenated alkyl-based solvent (such as chloroform or dichloromethane); an aromatic hydrocarbon-based solvent (such as benzene or toluene); a phenol-based solvent (such as phenol or cresol); or an ether-based solvent (such as tetrahydrofuran (THF), 1,3-dioxolane, dimethyl ether, diethyl ether or p-cresol methyl ether). The above solvents may be used alone or in combination. In order to improve the solubility and reactivity of the diamine monomer and the dianhydride monomer, the solvent is preferably an amide-based solvent, such as DMAc, DMF and NMP. Further, the dehydrating agent includes, for example, but is not limited to, acetic anhydride, propionic anhydride, n-butyric anhydride, benzoic anhydride, or trifluoroacetic anhydride; the imidizing agent includes, for example, but is not limited to, pyridine, picoline, quinoline, or isoquinoline.

In the present embodiment, the kind number of the diamine monomer and the kind number of the dianhydride monomer used to prepare the polyimide are not limited as long as the polyimide has the glass transition temperature of about 128° C. to about 169° C., the 10% thermogravimetric loss temperature of about 490° C. to about 534° C., and the viscosity of about 100 cP to about 250 cP when the polyimide is dissolved in NMP and the solid content is 30 wt %, and has the characteristics of proper melt processability and solvent solubility. For example, the polyimide may be obtained by reacting one kind of diamine monomer with one kind of dianhydride monomer. For another example, the polyimide may be obtained by reacting kinds of diamine monomers with one kind of dianhydride monomer, reacting one kind of diamine monomer with kinds of dianhydride monomers, or reacting kinds of diamine monomers with kinds of dianhydride monomers.

In the meltblowing process of the present embodiment, the meltblowing temperature of the meltblown nonwoven fabric may be between about 300° C. and about 350° C. In general, in the process of unmodified polyetherimide meltblown nonwoven fabric, the meltblowing temperature is between about 380° C. and about 400° C. In view of this, the meltblown nonwoven fabric of the present embodiment can be manufactured at a reduced meltblowing temperature.

In the meltblowing process of the present embodiment, the temperature of the high-temperature and high-speed gas is between about 400° C. and about 450° C., and the drawing pressure of the high-temperature and high-speed gas is between about 3 kg/cm² and about 7 kg/cm². In addition, the high-temperature and high-speed gas may be air or nitrogen.

In the present embodiment, each meltblown fiber has a diameter of from about 1 μm to about 10 μm. That is, the meltblown nonwoven fabric of the present embodiment can be composed of extremely fine microfibers.

In the present embodiment, at a frequency of 10 GHz, the dielectric constant of the meltblown nonwoven is between about 1.8 and about 2.5, and the dielectric loss of the meltblown nonwoven is between about 0.0025 and about 0.0050. That is, the meltblown nonwoven fabric of the present embodiment has good dielectric properties. In this way, the meltblown nonwoven fabric of the present embodiment is suitable for use as a substrate in a flexible printed circuit board. Moreover, as described above, at a frequency of 10 GHz, the dielectric loss of the meltblown nonwoven fabric is between about 0.0025 and about 0.0050, so the meltblown nonwoven fabric can conform to the specification requirements of the fifth generation mobile networks (5G).

In the present embodiment, the LOI (limiting oxygen index) value of the meltblown nonwoven fabric is between about 30 and about 35. That is, the meltblown nonwoven fabric of the present embodiment has good flame retardancy.

It should be noted that, in the present embodiment, the meltblown nonwoven fabric includes the meltblown fibers of which the material contains the polyetherimide and the polyimide, and the glass transition temperature of the polyimide is between 128° C. and 169° C., the 10% thermogravimetric loss temperature of polyimide is between 490° C. and 534° C., and when the polyimide is dissolved in NMP and the solid content of the polyimide is 30 wt %, the viscosity of the polyimide is between 100 cP and 250 cP, so that the meltblown nonwoven fabric can have good heat resistance, good flame retardancy, good dimensional stability, good dielectric properties, low meltblowing temperature, and no dripping phenomenon after combustion.

Further, in each meltblown fiber of the present embodiment, the content of the polyimide is from about 1 part by weight to about 10 parts by weight based on the content of 100 parts by weight of the polyetherimide, and thus the polyetherimide can be regarded as the main component, and the polyimide can be regarded as a plasticizer for endowing the polyetherimide with good melt processability, thereby reducing the meltblowing temperature when manufacturing the meltblown fibers.

In addition, as described above, in the present embodiment, the polyetherimide imparts good heat resistance, good flame retardancy and good dyeability to the meltblown fibers comprising the polyetherimide and the polyimide. That is, the meltblown nonwoven fabric has good heat resistance, good flame retardancy and good dyeability.

In addition, the meltblown nonwoven fabric of the present embodiment can be applied to a thermoplastic carbon fiber composite material. In detail, because the material of the meltblown fibers in the meltblown nonwoven fabric includes the polyetherimide and the polyimide of which the glass transition temperature is between about 128° C. and about 169° C., the 10% thermogravimetric loss temperature is between about 490° C. and about 534° C., and when the polyimide is dissolved in NMP and the solid content is 30 wt %, the viscosity is between 100 cP and 250 cP, a process for producing a thermoplastic carbon fiber composite material by performing a thermo-pressing treatment on the said meltblown nonwoven fabric and a carbon fiber cloth can provide the following advantages. Due to the meltblown nonwoven fabric heated uniformly, the process is rapid and the resin impregnation is increased. Due to the low meltblowing temperature of the meltblown nonwoven fabric, the processing temperature is reduced. And, because the thermal degradation of the polyetherimide is not obvious and the melt process can be repeated on the polyetherimide, the process for producing the thermoplastic carbon fiber composite material has circular economy characteristics.

In addition, in order to provide a meltblown nonwoven fabric having good heat resistance, good flame retardancy, good chemical resistance, good thermal shrink resistance, good dielectric properties, low process temperature, and no dripping phenomenon after combustion, the present invention provides another meltblown nonwoven fabric, which can achieve the above advantages. Hereinafter, embodiments are listed as examples in which the present invention can be actually implemented accordingly.

Another embodiment of the present invention provides a meltblown nonwoven fabric including a plurality of meltblown fibers adhered to each other. In detail, the meltblown fibers are arbitrarily interlaced with each other. In the present embodiment, the basis weight of the meltblown nonwoven fabric is between about 5 g/m² and 100 g/m².

In the present embodiment, each of the meltblown fibers is made of a polyphenylene sulfide and a polyimide. That is, the raw material of the meltblown nonwoven fabric is a masterbatch (i.e., a composition) including a polyphenylene sulfide and a polyimide. In detail, in the present embodiment, a method for producing a masterbatch (i.e., a composition) including a polyphenylene sulfide and a polyimide comprises performing a melt process on the polyphenylene sulfide and the polyimide to mix the polyphenylene sulfide and the polyimide. The melt process is a process that melting, mutually bonding and mixing various materials (for example, the polyphenylene sulfide and the polyimide) by heating and/or applying pressure. In the present embodiment, the melt process may include, for example, (but is not limited to), a melt compounding process, a thermo-pressing process, a melt blowing process, or melt spinning process. In the present embodiment, the process temperature of the melt process may be between about 300° C. and about 350° C.

In the present embodiment, the meltblown nonwoven fabric may be produced by the steps of melting a composition including a polyphenylene sulfide and a polyimide at a high temperature, and discharging the molten composition from the spinning nozzle in fibrous form, and then drawing the discharged molten composition in fibrous form by a high-temperature and high-speed gas to obtain a plurality of meltblown fibers on the collecting device. In the present embodiment, a meltblown nonwoven fabric is obtained by directly collecting a plurality of meltblown fibers. However, the present invention is not limited thereto. In other embodiments, the collected meltblown fibers may be subjected to a thermo-pressing process to obtain a meltblown fiber membrane.

In each of the meltblown fibers of the present embodiment, the content of the polyimide may be from about 1 part by weight to about 10 parts by weight based on the content of 100 parts by weight of the polyphenylene sulfide. In other words, in the composition including the polyphenylene sulfide and the polyimide, the polyimide may be used in an amount of from about 1 part by weight to about 10 parts by weight based on the use amount of 100 parts by weight of the polyphenylene sulfide. If the polyimide is used in an amount of less than 1 part by weight, the melt processability of the polyphenylene sulfide cannot be significantly improved to produce the meltblown fibers; and if the polyimide is used in an amount of greater than 10 parts by weight, the continuous processability of the said composition is not good, and it is difficult to manufacture a uniform meltblown fiber nonwoven fabric or a membrane thereof.

The polyphenylene sulfide is a thermoplastic polymer. In the present embodiment, the polyphenylene sulfide may include a repeating unit represented by the following formula II:

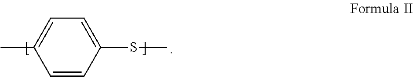

In the present embodiment, the polyphenylene sulfide may be a commercially available product, which is, for example, PPS TR03G manufactured by Dainippon Ink & Chemicals, Inc. (DIC). In addition, the polyphenylene sulfide inherently has good heat resistance, flame retardancy and chemical resistance, so the meltblown fibers of which the material includes the polyphenylene sulfide and the polyimide have good heat resistance, flame retardancy and chemical resistance.

In the present embodiment, the glass transition temperature of the polyimide is between about 128° C. and about 169° C., the 10% thermogravimetric loss temperature of the polyimide is between about 490° C. and about 534° C., and when the polyimide is dissolved in NMP and the solid content of the polyimide is about 30 wt %, the viscosity of the polyimide is between about 100 cP and about 250 cP. If the glass transition temperature, the 10% thermogravimetric loss temperature and the viscosity of the polyimide do not fall within the above range, the thermoplastic composition prepared in the subsequent step has poor melt processability and poor thermal stability. In the present embodiment, the polyimide is an ether group-containing polyimide, whereby the melt processability at high temperature of the said composition can be improved. Further, in the present embodiment, the polyimide may include a repeating unit represented by Formula 1:

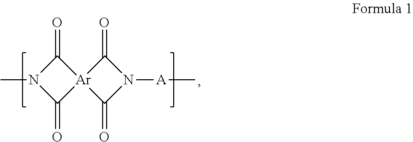

wherein Ar is a tetravalent organic group derived from a tetracarboxylic dianhydride compound containing aromatic group, and A is a divalent organic group derived from a diamine compound containing aromatic group. That is, Ar is a residue in the tetracarboxylic dianhydride compound containing aromatic group other than two carboxylic anhydride groups (—(CO)₂O); and A is a residue in the diamine compound containing aromatic group other than two amino groups (—NH₂). In this embodiment, at least one of the tetravalent organic group and the divalent organic group contains ether group. That is, at least one of the tetracarboxylic dianhydride compound containing aromatic group and the diamine compound containing aromatic group contains ether group. Herein, the tetracarboxylic dianhydride compound containing aromatic group is also referred to as a dianhydride monomer, and the diamine compound containing aromatic group is also referred to as a diamine monomer. In this embodiment, the polyimide is obtained by reacting the dianhydride monomer and the diamine monomer.

In this embodiment, Ar may be

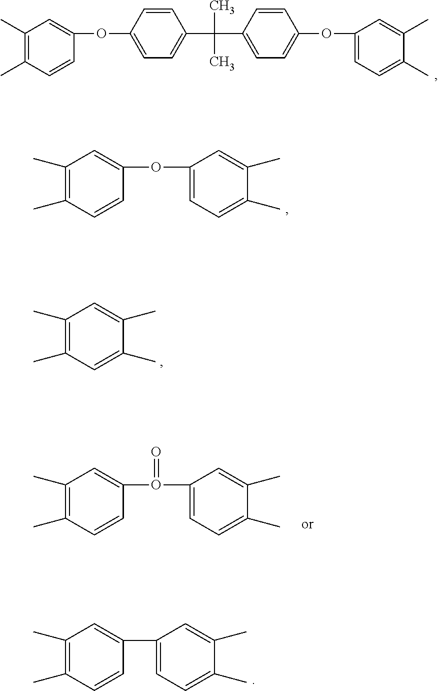

Specifically, the dianhydride monomer used to prepare the polyimide may be BPADA, ODPA, PMDA, BTDA, or BPDA.

In this embodiment, A may be

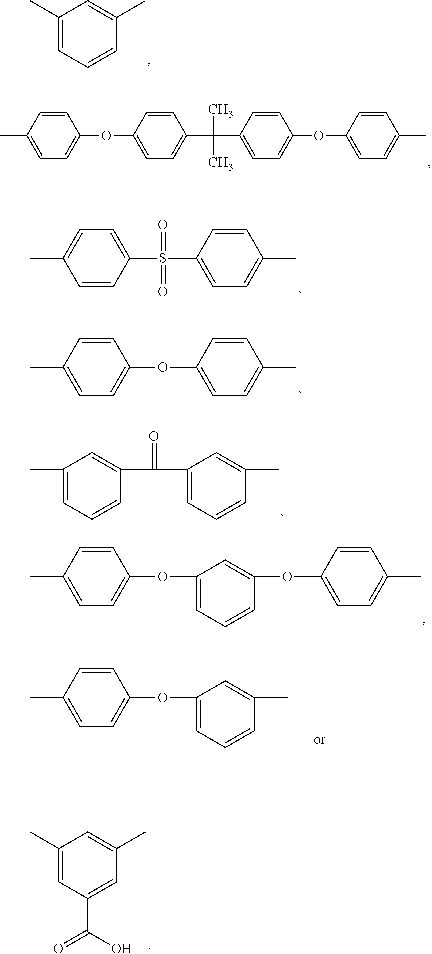

Specifically, the diamine monomer used to prepare the polyimide may be m-PDA, BAPP, 4,4′-diaminodiphenyl sulfone, ODA, 3,3′-diaminobenzophenone, TPE-R, 3,4′-oxydianiline (or 3,4′-diaminodiphenyl ether) or DABA.

In detail, in the present embodiment, the polyimide may be prepared, for example, by a polycondensation reaction and a thermal cyclization method, or by a polycondensation reaction and a chemical cyclization method. The polycondensation reaction, the thermal cyclization method, and the chemical cyclization method can each be carried out by any step known to those skilled in the art. In one embodiment, the preparation of the polyimide by a polycondensation reaction and a chemical cyclization method may include the steps of: subjecting a dianhydride monomer and a diamine monomer to a polycondensation reaction in a solvent to form a poly(amic acid) solution, and then adding a dehydrating agent and an imidizing agent to the poly(amic acid) solution to undergo an imidization reaction (i.e., a dehydration-cyclization reaction) to form the polyimide. In another embodiment, the preparation of the polyimide by a polycondensation reaction and a thermal cyclization method may include the steps of: subjecting a dianhydride monomer and a diamine monomer to a polycondensation reaction in a solvent to form a poly(amic acid) solution, and then heating the poly(amic acid) solution to undergo an imidization reaction (i.e., a dehydration-cyclization reaction) to form the polyimide.

The solvent is not particularly limited as long as it can dissolve the dianhydride monomer and the diamine monomer. Specifically, the solvent includes, for example, but is not limited to, an amide-based solvent (such as DMAc, DMF, N,N′-diethylacetamide, NMP, γ-butyrolactone, or hexamethylphosphoramide); a urea-based solvent (such as tetramethylurea or N,N-dimethylethylurea); an sulfoxide or sulfone-based solvent (such as DMSO, diphenyl sulfone or tetramethyl sulfone); a halogenated alkyl-based solvent (such as chloroform or dichloromethane); an aromatic hydrocarbon-based solvent (such as benzene or toluene); a phenol-based solvent (such as phenol or cresol); or an ether-based solvent (such as THF, 1,3-dioxolane, dimethyl ether, diethyl ether or p-cresol methyl ether). The above solvents may be used alone or in combination. In order to improve the solubility and reactivity of the diamine monomer and the dianhydride monomer, the solvent is preferably an amide-based solvent, such as DMAc, DMF and NMP. Further, the dehydrating agent includes, for example, but is not limited to, acetic anhydride, propionic anhydride, n-butyric anhydride, benzoic anhydride, or trifluoroacetic anhydride; the imidizing agent includes, for example, but is not limited to, pyridine, picoline, quinoline, or isoquinoline.

In the present embodiment, the kind number of the diamine monomer and the kind number of the dianhydride monomer used to prepare the polyimide are not limited as long as the polyimide has the glass transition temperature of about 128° C. to about 169° C., the 10% thermogravimetric loss temperature of about 490° C. to about 534° C., and the viscosity of about 100 cP to about 250 cP when the polyimide is dissolved in NMP and the solid content is 30 wt %, and has the characteristics of proper melt processability and solvent solubility. For example, the polyimide may be obtained by reacting one kind of diamine monomer with one kind of dianhydride monomer. For another example, the polyimide may be obtained by reacting kinds of diamine monomers with one kind of dianhydride monomer, reacting one kind of diamine monomer with kinds of dianhydride monomers, or reacting kinds of diamine monomers with kinds of dianhydride monomers.

In the meltblowing process of the present embodiment, the meltblowing temperature of the meltblown nonwoven fabric is between about 290° C. and about 310° C. In general, in the process of unmodified polyphenylene sulfide meltblown nonwoven fabric, the meltblowing temperature is between about 300° C. and about 320° C. In view of this, the meltblown nonwoven fabric of the present embodiment can be manufactured at a reduced meltblowing temperature.

In the meltblowing process of the present embodiment, the temperature of the high-temperature and high-speed gas is between about 300° C. and about 350° C., and the drawing pressure of the high-temperature and high-speed gas is between about 3 kg/cm² and about 7 kg/cm². In addition, the high-temperature and high-speed gas may be air or nitrogen.

In the present embodiment, each meltblown fiber has a diameter of from about 1 μm to about 10 μm. That is, the meltblown nonwoven fabric of the present embodiment can be composed of extremely fine microfibers.

In the present embodiment, at a frequency of 10 GHz, the dielectric constant of the meltblown nonwoven is between about 2.6 and about 2.9 and the dielectric loss of the meltblown nonwoven is between about 0.0030 and about 0.0050. That is, the meltblown nonwoven fabric of the present embodiment has good dielectric properties. In this way, the meltblown nonwoven fabric of the present embodiment is suitable for use as a substrate in a flexible printed circuit board. Moreover, as described above, at a frequency of 10 GHz, the dielectric loss of the meltblown nonwoven fabric is between about 0.0030 and about 0.0050, so the meltblown nonwoven fabric can conform to the specification requirements of the fifth generation mobile networks (5G).

In the present embodiment, the thermal shrinkage ratio of the meltblown nonwoven fabric after standing at a temperature of 140° C. for 24 hours is about 5% or less, and the thermal shrinkage ratio of the meltblown nonwoven fabric after standing at a temperature of 180° C. for 24 hours is about 10% or less. That is, the meltblown nonwoven fabric of the present embodiment has thermal shrink resistance at high temperature. In general, unmodified polyphenylene sulfide meltblown nonwoven fabric is often used at high temperature because of its high temperature resistance, but it has thermal shrinkage at high temperature. For example, the thermal shrinkage ratio of the unmodified polyphenylene sulfide meltblown nonwoven fabric after standing at a temperature of 140° C. for 24 hours is usually greater than 10%. In view of this, the meltblown nonwoven fabric of the present embodiment has good thermal shrink resistance at high temperature compared to the conventional unmodified polyphenylene sulfide meltblown nonwoven fabric.

In the present embodiment, the LOI value of the meltblown nonwoven fabric is between about 29 and about 31. That is, the meltblown nonwoven fabric of the present embodiment has good flame retardancy.

It should be noted that, in the present embodiment, the meltblown nonwoven fabric includes the meltblown fibers of which the material contains the polyphenylene sulfide and the polyimide, and the glass transition temperature of the polyimide is between 128° C. and 169° C., the 10% thermogravimetric loss temperature of polyimide is between 490° C. and 534° C., and when the polyimide is dissolved in NMP and the solid content of the polyimide is 30 wt %, the viscosity of the polyimide is between 100 cP and 250 cP, thereby the meltblown nonwoven fabric can have good heat resistance, good flame retardancy, good chemical resistance, good thermal shrink resistance, good dielectric properties, low process temperature, and no dripping phenomenon after combustion.

Further, in each of the meltblown fibers of the present embodiment, the content of the polyimide is from about 1 part by weight to about 10 parts by weight based on the content of 100 parts by weight of the polyphenylene sulfide, and thus the polyphenylene sulfide can be regarded as the main component, and the polyimide can be regarded as a plasticizer for endowing the polyphenylene sulfide with good melt processability, thereby reducing the meltblowing temperature when manufacturing the meltblown fibers.

Further, as described above, in the present embodiment, the polyphenylene sulfide imparts good heat resistance, good flame retardancy, and good chemical resistance to the meltblown fibers comprising the polyphenylene sulfide and the polyimide. That is, the meltblown nonwoven fabric has good heat resistance, good flame retardancy and good chemical resistance.

Further, as described above, in the present embodiment, the meltblown nonwoven fabric has good chemical resistance and is composed of extremely fine microfibers, whereby the meltblown nonwoven fabric can be used as a filter membrane or even as a filter membrane for organic solvent.

Features of the present invention will be more specifically described below with reference to Examples 1 to 3 and Comparative Examples 1 to 2. Although the following examples are described, the materials used, the amounts and ratios thereof, the processing details, the processing flow, and the like can be appropriately changed without departing from the scope of the invention. Therefore, the invention should not be construed restrictively by the examples described below.

### Synthesis Example 1

After the polyimide of Synthesis Example 1 was formed according to the method of preparing the polyimide disclosed in the foregoing, the glass transition temperatures (Tg), the 10% thermogravimetric loss temperatures (T_{d10%}) and the viscosities of the polyimide of Synthesis Example 1 were respectively measured. The description of the aforementioned measurements is as follows, and the measurement results are shown in Table 1.

### <Measurement of Glass Transition Temperature (Tg)>

The glass transition temperature (° C.) of the polyimide of Synthesis Example 1 was measured under a nitrogen atmosphere at a heating rate of 10° C./min by using a thermomechanical analyzer (manufactured by Maia Co., Ltd., model: DSC200 F3).

### <Measurement of 10% Thermogravimetric Loss Temperature (T_{d10%})>

The polyimide of Synthesis Example 1 was measured under a nitrogen atmosphere at a heating rate of 20° C./min by using a thermogravimetric analyzer (manufactured by TA Instruments, model: Q50), and the change in weight of the polyimide was recorded, where the temperature measured when the polyimide lost 10% by weight was the 10% thermogravimetric loss temperature (° C.).

### <Measurement of Viscosity>

Firstly, the polyimide of Synthesis Example 1 was dissolved in the solvent NMP to form a sample solution having a solid content of 30 wt %. Next, the viscosity (cP) of the sample solution was measured at room temperature by using a rotary viscometer (manufactured by Brookfield Co., Ltd., Model: DV-II+Pro Viscometer).

TABLE 1

| | Tg (° C.) | T_{d10%} (° C.) | Viscosity (cP) |
|---|---|---|---|
| Synthesis Example 1 | 141 | 509 | 100 |

### Example 1

The masterbatch of Example 1 was prepared by the following steps. A melt-blending granulation process was performed on 100 parts by weight of polyetherimide (ULTEM 1010 PEI manufactured by Sabic) and 5 parts by weight of polyimide of Synthesis Example 1 placed in a twin screw extruder at 320° C. to obtain the masterbatch (i.e., the composition) of Example 1.

Next, the masterbatch of Example 1 was subjected to a meltblowing process to produce the meltblown nonwoven fabric of Example 1, wherein the conditions of the meltblowing process were as follows: the meltblowing temperature was about 345° C., the nozzle aperture was about 0.3 mm, the temperature of the high-temperature and high-speed gas was about 450° C., the drawing pressure of the high-temperature and high-speed gas was about 7 kg/cm², the rotation speed was about 8 rpm, and the collection distance was about 15 cm. The basis weight of the meltblown nonwoven fabric of Example 1 was about 10 g/m², the thickness of the meltblown nonwoven fabric of Example 1 was about 0.022 mm, and the average diameter of the meltblown fibers in the meltblown nonwoven fabric of Example 1 was about 4 μm.

### Example 2

The t masterbatch of Example 2 was prepared by the following steps. A melt-blending granulation process was performed on 100 parts by weight of polyetherimide (ULTEM 1010 PEI manufactured by Sabic) and 7 parts by weight of polyimide of Synthesis Example 1 placed in a twin screw extruder at 320° C. to obtain the masterbatch (i.e., the composition) of Example 2.

Next, the masterbatch of Example 2 was subjected to a meltblowing process to produce the meltblown nonwoven fabric of Example 2, wherein the conditions of the meltblowing process were as follows: the meltblowing temperature was about 350° C., the nozzle aperture was about 0.3 mm, the temperature of the high-temperature and high-speed gas was about 470° C., the drawing pressure of the high-temperature and high-speed gas was about 7 kg/cm², the rotation speed was about 9 rpm, and the collection distance was about 20 cm. The basis weight of the meltblown nonwoven fabric of Example 2 was about 15 g/m², the thickness of the meltblown nonwoven fabric of Example 2 was about 0.05 mm, and the average diameter of the meltblown fibers in the meltblown nonwoven fabric of Example 2 was about 10 μm.

### Example 3

The masterbatch of Example 3 was prepared by the following steps. A melt-blending granulation process was performed on 100 parts by weight of polyphenylene sulfide (PPS TR03G manufactured by DIC) and 3.7 parts by weight of polyimide of Synthesis Example 1 placed in a twin screw extruder at 300° C. to obtain the masterbatch (i.e., the composition) of Example 3.

Next, the masterbatch of Example 3 was subjected to a meltblowing process to produce the meltblown nonwoven fabric of Example 3, wherein the conditions of the meltblowing process were as follows: the meltblowing temperature was about 300° C., the nozzle aperture was about 0.3 mm, the temperature of the high-temperature and high-speed gas was about 320° C., the drawing pressure of the high-temperature and high-speed gas was about 7 kg/cm², the rotation speed was about 8 rpm, and the collection distance was about 3 cm. The basis weight of the meltblown nonwoven fabric of Example 3 was about 90 g/m², the thickness of the meltblown nonwoven fabric of Example 3 was about 0.20 mm, the average pore diameter of the meltblown nonwoven fabric of Example 3 was about 2.54 μm, and the average diameter of the meltblown fibers in the meltblown nonwoven fabric of Example 3 was about 1.9 μm.

### Comparative Example 1

In Comparative Example 1, only polyphenylene sulfide (PPS TR03G manufactured by DIC) was used as a masterbatch. The said masterbatch was subjected to a meltblowing process to produce the meltblown nonwoven fabric of Comparative Example 1, wherein the conditions of the meltblowing process were as follows: the meltblowing temperature was about 300° C., the nozzle aperture was about 0.3 mm, the temperature of the high-temperature and high-speed gas was about 320° C., the drawing pressure of the high-temperature and high-speed gas was about 7 kg/cm², the rotation speed was about 8 rpm, and the collection distance was about 6 cm. The basis weight of the meltblown nonwoven fabric of Comparative Example 1 was about 80 g/m², the thickness of the meltblown nonwoven fabric of Comparative Example 1 was about 0.25 mm, the average pore diameter of the meltblown nonwoven fabric of Comparative Example 1 was about 10.36 μm, and the average diameter of the meltblown fibers in the meltblown nonwoven fabric of Comparative Example 1 was about 4.3 μm. That is, in Comparative Example 1, the commercially available polyphenylene sulfide PPS TR03G manufactured by DIC was directly used to manufacture a meltblown nonwoven fabric.

### Comparative Example 2

In Comparative Example 2, only polyphenylene sulfide (PPS TR03G manufactured by DIC) was used as a masterbatch. The said masterbatch was subjected to a meltblowing process to produce the meltblown nonwoven fabric of Comparative Example 2, wherein the conditions of the meltblowing process were as follows: the meltblowing temperature was about 300° C., the nozzle aperture was about 0.3 mm, the temperature of the high-temperature and high-speed gas was about 320° C., the drawing pressure of the high-temperature and high-speed gas was about 7 kg/cm², the rotation speed was about 8 rpm, and the collection distance was about 4 cm. The basis weight of the meltblown nonwoven fabric of Comparative Example 2 was about 80 g/m², the thickness of the meltblown nonwoven fabric of Comparative Example 2 was about 0.25 mm, the average diameter of the meltblown fibers in the meltblown nonwoven fabric of Comparative Example 2 was about 10 μm. That is, in Comparative Example 2, the commercially available polyphenylene sulfide PPS TR03G manufactured by DIC was directly used to manufacture a meltblown nonwoven fabric.

Comparing the specifications of the meltblown nonwoven fabric of Example 3 with the specifications of the meltblown nonwoven fabric of Comparative Example 1, it is understood that under the same meltblowing conditions, the average diameter (1.9 μm) of the meltblown fibers in the meltblown nonwoven fabric of Example 3 is smaller than the average diameter (4.3 μm) of the meltblown fibers in the meltblown nonwoven fabric of Comparative Example 1, and the average pore diameter (2.54 μm) of the meltblown nonwoven fabric of Example 3 is smaller than the average pore diameter (10.36 μm) of the meltblown nonwoven fabric of Comparative Example 1. The results show that the material of the meltblown fibers in the meltblown nonwoven fabric of the present invention includes the polyphenylene sulfide and the polyimide of which the glass transition temperature is between about 128° C. and about 169° C., the 10% thermogravimetric loss temperature is between about 490° C. and about 534° C., and when the polyimide is dissolved in NMP and the solid content is 30 wt %, the viscosity is between about 100 cP and about 250 cP, so that the meltblown nonwoven fabric of the present invention can have extremely fine fibers and small pore diameter.

Further, the dielectric constants and the dielectric losses of the meltblown nonwoven fabrics of Examples 1-3 were respectively measured, the LOI values of the meltblown nonwoven fabrics of Examples 1-3 were respectively tested, the thermal shrinkage ratios and the tensile strengths of the meltblown nonwoven fabrics of Example 3 and Comparative Example 2 were respectively measured, and the chemical resistances of the meltblown nonwoven fabrics of Example 3 and Comparative Example 2 were respectively evaluated. The description of the above measurement items is as follows, and the measurement results are shown in Table 2, Table 3, Table 4, and Table 5.

### <Measurement of Dielectric Constant and Dielectric Loss>

First, the meltblown nonwoven fabric of each of Examples 1-3 was made into a sample with length and width dimensions of 10 cm×10 cm. Then, each of the samples was baked in an oven at 100° C. for 6 hours, and then the dielectric constant and the dielectric loss of each of the samples was measured by a dielectric constant measuring device at measuring frequency of 10 GHz. The measurement results are shown in Table 2 below.

TABLE 2

| | Dielectric constant | Dielectric loss |
|---|---|---|
| Example 1 | 1.98~2.34 | 0.0025~0.0030 |
| Example 2 | 1.8~2.4 | 0.0030~0.0050 |
| Example 3 | 2.6~2.9 | 0.0030~0.0050 |

As can be seen from the above Table 2, the meltblown nonwoven fabric of each of Examples 1-3 has low dielectric constant and low dielectric loss, and the performance of the dielectric loss meets the specification requirements of 5G (i.e., the dielectric loss (DO is equal to or less than 0.0050). The results show that the material of the meltblown fibers in the meltblown nonwoven fabric of the present invention includes the polyetherimide and the polyimide of which the glass transition temperature, the 10% thermogravimetric loss temperature, and the viscosity when the polyimide is dissolved in NMP and has the solid content of 30 wt % are respectively within specific ranges, or includes the polyphenylene sulfide and the polyimide of which the glass transition temperature, the 10% thermogravimetric loss temperature, and the viscosity when the polyimide is dissolved in NMP and has the solid content of 30 wt % are respectively within specific ranges, so that the meltblown nonwoven fabric of the present invention can have good dielectric properties.

### <Test of LOI Value>

The LOI values of the meltblown nonwoven fabrics of Examples 1-3 were respectively tested in accordance with the specifications of ASTM D2863, and the test results of are shown in Table 3 below. Further, during the testing of LOI value, it was visually observed whether the meltblown nonwoven fabric of each of Examples 1-3 has dripping phenomenon after combustion, and the evaluation results are also shown in Table 3 below. In general, when the LOI value is ≥28, it means that the flame retardancy is good.

TABLE 3

| | Flame retardant effect | |
|---|---|---|
| | LOI value | Dripping or not |
| Example 1 | 31 | no |
| Example 2 | 31 | no |
| Example 3 | 34 | no |

As can be seen from the above Table 3, the LOI values of the meltblown nonwoven fabrics of Examples 1-3 were 31, 31, and 34, respectively, and all the meltblown nonwoven fabrics of Examples 1-3 have no dripping phenomenon after combustion. The results show that the material of the meltblown fibers in the meltblown nonwoven fabric of the present invention includes the polyetherimide and the polyimide of which the glass transition temperature, the 10% thermogravimetric loss temperature, and the viscosity when the polyimide is dissolved in NMP and has the solid content of 30 wt % are respectively within specific ranges, or includes the polyphenylene sulfide and the polyimide of which the glass transition temperature, the 10% thermogravimetric loss temperature, and the viscosity when the polyimide is dissolved in NMP and has the solid content of 30 wt % are respectively within specific ranges, so that the meltblown nonwoven fabric of the present invention can have good flame retardant effect and no dripping phenomenon.

### <Measurement of Thermal Shrinkage Ratio>

First, the meltblown nonwoven fabrics of Example 3 and Comparative Example 2 were respectively made into a plurality of square samples each with a length dimension of 10 cm. Then, after the samples of the meltblown nonwoven fabric of Example 3 were respectively stood at temperatures of 80° C., 140° C., and 180° C. for 24 hours, and also the samples of the meltblown nonwoven fabric of Comparative Example 2 were respectively stood at temperatures of 80° C., 140° C., and 180° C. for 24 hours, the length dimension of each sample was measured. After that, the thermal shrinkage ratio of each sample was calculated by the following formula: thermal shrinkage ratio=100%×[(original length of nonwoven−length of nonwoven after standing at a specific temperature for 24 hours)/original length of nonwoven]. The calculated results are shown in Table 4 below. In Table 4, the smaller the value, the better the thermal shrink resistance of the meltblown nonwoven fabric.

### <Measurement of Tensile Strength>

First, the meltblown nonwoven fabric of each of Example 3 and Comparative Example 2 was made into a sample with length and width dimensions of 150 mm×25 mm and with a shape of dumbbell or dog bone. Then, according to the specifications of ASTM D5034, the tensile strength (kgf) of each sample along the machine direction (MD) was measured by a tensile tester (model GT-7001-MC10, manufactured by Gotech Testing Machines Inc.) at the stretching rate of 300 mm/min. The measurement results are shown in Table 4 below. In Table 4, the larger the value, the better the mechanical properties of the meltblown nonwoven fabric.

TABLE 4

| | Thermal shrinkage ratio (%) | | | Tensile strength |
|---|---|---|---|---|
| | 80° C. | 140° C. | 180° C. | (kgf) |
| Example 3 | 0 | 5 | 10 | 18 |
| Comparative | 0 | 18 | 30 | 18 |
| Example 2 | | | | |

As can be seen from the above Table 4, the meltblown nonwoven fabric of Example 3 exhibited better thermal shrink resistance after standing at temperatures of 140° C. and 180° C. for 24 hours as compared with the meltblown nonwoven fabric of Comparative Example 2 produced using only polyphenylene sulfide. The results show that the material of the meltblown fibers in the meltblown nonwoven fabric of the present invention includes the polyphenylene sulfide and the polyimide of which the glass transition temperature, the 10% thermogravimetric loss temperature, and the viscosity when the polyimide is dissolved in NMP and has the solid content of 30 wt % are respectively within specific ranges, so that the thermal shrink resistance of the meltblown nonwoven fabric of the present invention can be improved.

Further, as can be seen from the above Table 4, the meltblown nonwoven fabric of Example 3 and the meltblown nonwoven fabric of Comparative Example 2 had similar tensile strengths. The results show that the meltblown nonwoven fabric of the present invention in which the material of the meltblown fibers includes the polyphenylene sulfide and the polyimide of which the glass transition temperature, the 10% thermogravimetric loss temperature, and the viscosity when the polyimide is dissolved in NMP and has the solid content of 30 wt % are respectively within specific ranges may have similar mechanical properties to the meltblown nonwoven fabric produced using only polyphenylene sulfide.

### <Evaluation of Chemical Resistance>

First, the meltblown nonwoven fabrics of Example 3 and Comparative Example 2 were separately made into a plurality of samples each with a weight of 10 g. Then, at a specific temperature, after the samples of the meltblown nonwoven fabric of Example 3 were respectively soaked in various chemical solvents for a certain period of time, and also the samples of the meltblown nonwoven fabric of Comparative Example 2 were respectively soaked in various chemical solvents for a certain period of time, the weight (g) of each sample was measured. After that, the weight loss of each sample was calculated by the following formula: weight loss=100%×[(weight of sample after soaked−weight of sample before soaked)/weight of sample before soaked], and the chemical resistance of each sample was evaluated according to the following chemical resistance evaluation standard. The soaking condition and the evaluation result of each sample are shown in Table 5 below.

<Chemical Resistance Evaluation Standard>

O: weight loss=0%

X: weight loss≠0%

TABLE 5

| | | Exam- | Comparative |
|---|---|---|---|
| | | ple 3 | example 2 |
| Soaking | Toluene solvent | O | O |
| condition | (Temperature: 50° C., time: 1 hour) | | |
| | Para-xylene solvent | O | O |
| | (Temperature: 50° C., time: 1 hour) | | |
| | 1M nitric acid solvent | O | O |
| | (Temperature: 50° C., time: 1 hour) | | |
| | 37% hydrochloric acid solvent | O | O |
| | (Temperature: 50° C., time: 1 hour) | | |
| | 50% sodium hydroxide solvent | O | O |
| | (Temperature: 80° C., time: 1 hour) | | |
| | 50% sodium hydroxide solvent | O | O |
| | (Temperature: 180° C., time: 8 hours) | | |

As can be seen from the above Table 5, after the meltblown nonwoven fabric of Example 3 and the meltblown nonwoven fabric of Comparative Example 2 were each soaked in an acidic or basic chemical solvent at a specific temperature for a certain period of time, there is no weight loss occurred. That is, the fiber structure of the meltblown nonwoven fabric of Example 3 and the fiber structure of the meltblown nonwoven fabric of Comparative Example 2 were not corroded by the acidic chemical solvent or the basic chemical solvent. The results show that the meltblown nonwoven fabric of the present invention in which the material of the meltblown fibers includes the polyphenylene sulfide and the polyimide of which the glass transition temperature, the 10% thermogravimetric loss temperature, and the viscosity when the polyimide is dissolved in NMP and has the solid content of 30 wt % are respectively within specific ranges may have similar and good chemical resistance to the meltblown nonwoven fabric made only of polyphenylene sulfide.

Although the present invention is disclosed with reference to embodiments above, the embodiments are not intended to limit the present invention. Any person of ordinary skill in the art may make some variations and modifications without departing from the spirit and scope of the invention, and therefore, the protection scope of the present invention should be defined in the following claims.

What is claimed is:

1. A meltblown nonwoven fabric, comprising:
a plurality of meltblown fibers adhered to each other, wherein a material of each of the plurality of meltblown fibers comprises:
a polyetherimide; and
a polyimide, wherein a glass transition temperature of the polyimide is between 128° C. and 169° C., a 10% thermogravimetric loss temperature of the polyimide is between 490° C. and 534° C., and when the polyimide is dissolved in N-methyl-2-pyrrolidone (NMP) and a solid content of the polyimide is 30 wt %, a viscosity of the polyimide is between 100 cP and 250 cP.

2. The meltblown nonwoven fabric according to claim 1, wherein a content of the polyimide is from 1 part by weight to 10 parts by weight based on a content of 100 parts by weight of the polyetherimide.

3. The meltblown nonwoven fabric of claim 1, wherein each of the plurality of meltblown fibers has a diameter of from 1 μm to 10 μm.

4. The meltblown nonwoven fabric of claim 1, wherein a dielectric constant of the meltblown nonwoven fabric is between 1.8 and 2.5 at a frequency of 10 GHz.

5. The meltblown nonwoven fabric of claim 1, wherein a dielectric loss of the meltblown nonwoven fabric is between 0.0025 and 0.0050 at a frequency of 10 GHz.

6. The meltblown nonwoven fabric of claim 1, wherein an LOI value of the meltblown nonwoven fabric is between 30 and 35.

7. The meltblown nonwoven fabric of claim 1, wherein a meltblowing temperature of the meltblown nonwoven fabric is between 300° C. and 350° C.

8. A meltblown nonwoven fabric, comprising:
a plurality of meltblown fibers adhered to each other, wherein a material of each of the plurality of meltblown fibers comprises:
a polyphenylene sulfide; and
a polyimide, wherein a glass transition temperature of the polyimide is between 128° C. and 169° C., a 10% thermogravimetric loss temperature of the polyimide is between 490° C. and 534° C., and when the polyimide is dissolved in N-methyl-2-pyrrolidone and a solid content of the polyimide is 30 wt %, a viscosity of the polyimide is between 100 cP and 250 cP.

9. The meltblown nonwoven fabric according to claim 8, wherein a content of the polyimide is from 1 part by weight to 10 parts by weight based on a content of 100 parts by weight of the polyphenylene sulfide.

10. The meltblown nonwoven fabric of claim 8, wherein each of the plurality of meltblown fibers has a diameter of from 1 μm to 10 μm.

11. The meltblown nonwoven fabric of claim 8, wherein a dielectric constant of the meltblown nonwoven fabric is between 2.6 and 2.9, and a dielectric loss of the meltblown nonwoven fabric is between 0.0030 and 0.0050 at a frequency of 10 GHz.

12. The meltblown nonwoven fabric according to claim 8, wherein the meltblown nonwoven fabric has a thermal shrinkage ratio of 5% or less after standing at a temperature of 140° C. for 24 hours, and has a thermal shrinkage ratio of 10% or less after standing at a temperature of 180° C. for 24 hours thermal shrinkage ratio.

13. The meltblown nonwoven fabric of claim 8, wherein an LOI value of the meltblown nonwoven fabric is between 29 and 31.

14. The meltblown nonwoven fabric of claim 8, wherein a meltblowing temperature of the meltblown nonwoven fabric is between 290° C. and 310° C.
